(19) United States
(12) Patent Application Publication
(10) Pub. No.: US 2025/0304494 A1
(43) Pub. Date: Oct. 2, 2025

(54) A COMPOSITE PRODUCT

(71) Applicant: NORSK HYDRO ASA, Oslo (NO)

(72) Inventors: Trond FURU, Sunndalsøra (NO); Grete HJETLAND, Bekkestua Oslo (NO); Harald VESTØL, Kolbotn (NO)

(73) Assignee: NORSK HYDRO ASA, Oslo (NO)

(21) Appl. No.: 18/873,007

(22) PCT Filed: Jun. 15, 2023
(86) PCT No.: PCT/EP2023/066097

§ 371 Date: Dec. 9, 2024

(30) Foreign Application Priority Data
Jun. 17, 2022 (NO) 20220691
Apr. 26, 2023 (NO) 20230461

(51) Int. Cl. C04B 14/00; C04B 28/02; C04B 103/61; C04B 111/00; C04B 111/26; E04C 5/04

(52) U.S. Cl. CPC C04B 14/005; C04B 28/02; E04C 5/04; C04B 2103/61; C04B 2111/00612; C04B 2111/00844; C04B 2111/26

(57) ABSTRACT

A reinforced composite product of concrete (14) reinforced by reinforcement mesh(s) (13, 13′) of an aluminium alloy. where calcium hydroxide of the concrete is absent to avoid or reduce corrosion of the aluminium reinforcement by replacing cement with >35% active pozzolana and that the mesh can be made by slit-stretching or by punching a sheet aluminium metal. The aluminium mesh is advantageous for use as reinforcement in various concrete structures in corrosive environment and where traditional steel meshes are used today.

The present invention relates to a composite product of aluminium metal reinforced concrete, where the product is stabilized against corrosion. The invention further relates to a method of applying reinforcement mesh of aluminium alloys in concrete products where the mesh is not prone to corrosion. The composite products produced can be low-stress constructions and structures subject to compression such as slabs, walls, façade panels, the outer layer of prefabricated sandwich wall elements, paving, pathways, steps for stairways, foundations, columns or the similar. The mesh can also be used in a load bearing structure such as a composite structure.

Commonly, metal of steel qualities is applied as reinforcement mesh for concrete products.

The main durability design of concrete is in relation to preventing the steel reinforcement from corroding. The major degradation process; chloride ingress and carbonation, does not jeopardize the integrity of the concrete binder itself. Steel needs the high pH of conventional concrete to be passive towards corrosion. A challenge with aluminium metal is that it can be corroded by high pH of the concrete and develop hydrogen gas. One remedy can be to protect the aluminium by a coating or the similar,—where the coating constitutes an extra step in the production process—and may also be damaged during casting

Environmentally friendly concrete is often designed by either using blended cement where maximum 35% of the clinker is replaced by pozzolanic supplementary cementitious materials (SCMs) to secure the presence of calcium hydroxide over time that will buffer a pH of 12.5 passivating steel, or by replacing cement in concrete mixes with corresponding amounts of SCM.

GB 1534375 with priority from 1975 relates to coated concrete panels where an autoclaved lightweight concrete panel preferably comprising portland or silica cement, sand, lime and water glass or gypsum has metal wire netting, metal lath or expanded metal pressed into one or both surfaces of the panel after the panel has been cured and hardened in an autoclave. The pressure is applied by presses or rollers having pressure surfaces corresponding to the wires of the mesh. The netting is preferably formed from iron, steel, stainless steel, aluminium or brass and may be coated with zinc or tin and a paint. The wire may be completely buried in the surface or may project therefrom. The surface of the panel may be impregnated with synthetic resin before the wire netting is pressed therein. The surfaces of the panels may be coated after the mesh has been pressed therein with e.g. portland, alumina or magnesia cement or plaster. A number of panels may be bound together side by side by adhesive e.g. cement, synthetic resin tar or pitch, before a large sheet of netting is pressed into their surfaces.

One challenge related to the present invention is to make environmentally friendly concrete with cement replacement >35% with a combination of SCMs (Supplementary Cementitious Materials) where some are so pozzolanic active that the calcium hydroxide (CH) produced by cement hydration is consumed quickly so that the concrete can be reinforced with aluminium metal mesh without formation of hydrogen gas. The w/c (water/cement) ratio can then be so high that it is only determined by required compressive strength. With a high w/c workability should not be a problem and neither hydration generated heat (also due to lower cement content). Permeability is no longer important as aluminium metal is resilient to atmospheric CO₂ and chlorides (at least when properly alloyed), and high initial permeability is in fact beneficial for the concrete to carbonate as fast as possible to reduce the carbon footprint further and lower the pH for the long run. The concrete cover over the reinforcement can be made much thinner (20 mm), or it can be left out completely, than with steel today (40-70 mm), reducing weight and further improving the carbon footprint. The present invention can benefit greatly from this as the composite product can be made much thinner and lighter.

The easiest approach to implement concrete without calcium hydroxide is to make a blended cement with a pozzolanic SCM (i.e., one consuming calcium hydroxide from hydration of clinker minerals) exceeding 35% clinker replacement and up to a level of 50-60% depending on target strength level.

The calcium hydroxide produced by the hydration of clinker minerals in ordinary Portland cement would lead to a buffered pH of about 12.5, while the alkalis (0.6-1.2% Na₂O_{equivalent}) of the cement clinker will top this to pH 13.0-13.5.

Aluminium metal forms a dense layer of Al₂O₃ in contact with air that prevents further oxidation (or corrosion).

As long as one has a surplus of a SCM relative to CH production (>35% replacing cement) with high surface, the soluble alkalis should be in the form of aluminates and silicates and should in theory not attack the aluminium metal. If the SCM replacement is less than 35% these alkali aluminates and silicates will regenerate in reaction with CH back to alkali hydroxide when all SCM is consumed, and the aluminium metal can again be attacked (Eq. 4). For instance, 0.1 M NaOH has pH 13.0, 0.1 M Na₂SiO₃ has pH 12.6 (0.04 M OH⁻) that further reduces as Na/Si reduces. Pure “water glass” with Na/Si=2 has pH 11.3 (0.002 M OH⁻ or a reduction factor of 50) for a 35% solution that might be reduced further when diluted. The pH is due to equilibrium with water, and the question remains whether soluble silicates will attack aluminium metal at all or rather function as an inhibitor.

Another aspect of high cement replacement with SCM is that the early strength of the concrete may be low, and a hardening accelerator might be needed. That is why calcium chloride is included as a component in the mixing water. The most effective and cheapest hardening accelerator for concrete used to be calcium chloride, but it has been omitted the later years due to corrosion initiation of steel by the chlorides. This is not a problem for aluminium reinforcement as common aluminium alloys are more resilient towards chlorides.

Furthermore, pozzolanic SCM like calcined clay produces calcium aluminate hydrates over time, chlorides will be taken out of solution and bound as Friedel's salt; Ca₃Al₂O₆·CaCl₂·12H₂O. The soluble calcium in calcium chloride will further depress the initial pH of the pore water due to the common ion effect with calcium hydroxide. Therefore, calcium chloride will both act as an accelerator for cement and at the same time reduce the early etching of aluminium.

The question is which pozzolanic SCM to choose. It should be one with a high specific surface consisting of silica, aluminosilicate or alumina. If one considers the passive layer of aluminium as alumina, the initial alkali hydroxides from cement should be busy dissolving the SCM rather than the passive layer of the aluminium.

The most common pozzolanic SCM used by cement industry today is fly ash from coal fired energy plants. These are tiny spheres with glassy aluminosilicate walls to put it simple. However, the glass phase reacts rather slowly (i.e. strength improvement after 14 days) compared to for instance silica fume (within a day) and “ordinary blue clay” as dug from the ground with all its contaminations and calcined at about 800° C. A combination of fly ash and calcined clay is possible and demonstrated to give a good workability together. VPI (volcanic pozzolan island) has also been tested with good results.

Besides optimizing the composition of the concrete, it has been found that using salt water and possibly sea sand, the pH level can be brought to an acceptable level to avoid corrosion of the aluminium meshs. This is because the magnesium ions in sea water will react with initial alkali hydroxides in the mix and precipitate the hydroxides as brucite, Mg(OH)₂, with an equilibrium pH of 10.5. Some preferred aspects related to the concrete;
the active pozzolana is calcined clay
the active pozzolana is Volcanic Pozzolan Island (VPI)
the active pozzolana is fly ash
the binder comprises <50/>50 cement/active pozzolana.

Preferably, the binder comprises <65% cement and >35% active pozzolana

However, according to some aspects of the invention the binder may comprise:
<60% cement and >40% active pozzolana
<55% cement and >45% active pozzolana
<50% cement and >50% active pozzolana
<45% cement and >55% active pozzolana
<40% cement and >60% active pozzolana
<35% cement and >65% active pozzolana
   the binder comprises calcined clay containing kaolinite or smectite.
   the binder is added calcium chloride as accelerator either as powder or dissolved in the mixing water

One aspect of the invention is to make reinforcing mesh in aluminium for use in low-emission concrete where steel reinforcing mesh cannot be used, due to in particular corrosion issues.

One other aspect of the invention is to provide efficient ways to manufacture standardized reinforcing meshes in aluminium—preferably from post-consumed aluminium—for use in the construction industry where a low-emission concrete specially designed for compatibility with aluminium is used.

The present concept is related to advantages that match steps to be taken in relation to the “green shift”:
The aluminium reinforcement must not be protected in the specific concrete=>slimmer design, lower weight
Less use of materials, concrete, aggregate
Less energy to produce the binder
Less CO2 emissions from the binder production
“Infinite” lifetime
Reduced maintenance
New design options
Natural sea water may be used as mixing water
The aggregate may be coated with salt
AI reinforcement: conducting electricity, thermal conductivity, new applications
   Solar collectors
   Icefree paving, pathways, stairways
   Energy saving, less energy needed for reaching set temp due to thinner concrete cover

The possibility of reinforcing concrete with aluminium reinforcement mesh has several advantages, among them reduced weight of the final product due to slimmer design of the product.

Lighter reinforcement material is ergonomically better for the reinforcement worker to handle and is also believed to make the reinforcement work more efficient

These and further advantages that will be achieved by the invention as defined in the accompanying claims.

The present invention will in the following be further described by figures and examples where:

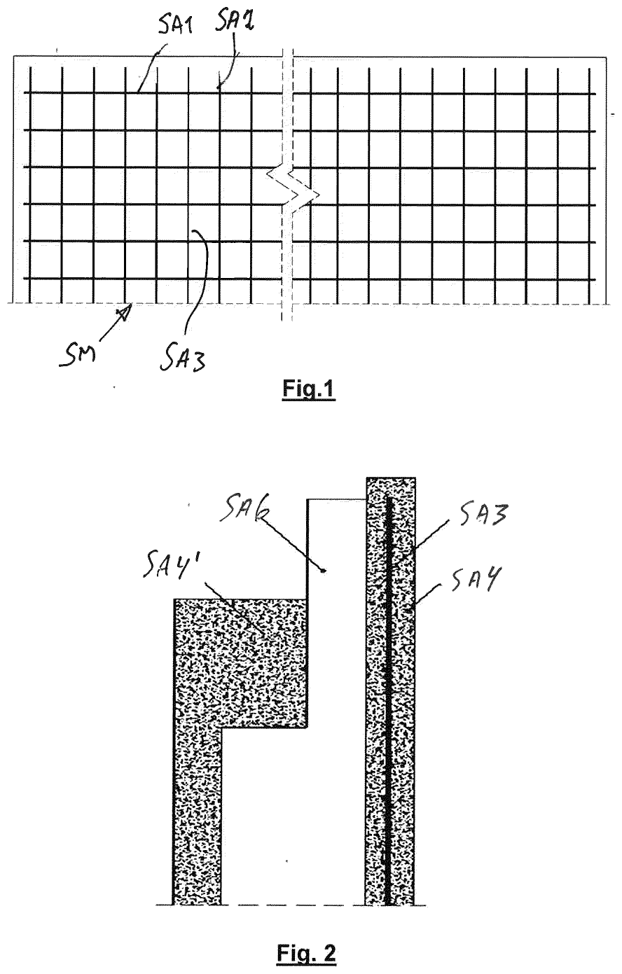

FIG. 1 discloses a top-view cut at the level of a steel reinforcement mesh of a state of the art prefabricated sandwich element,

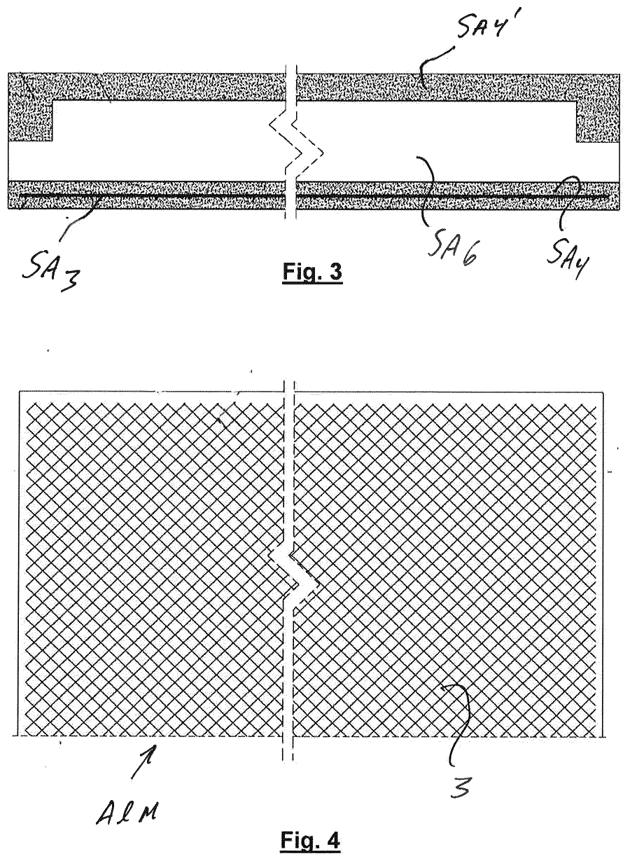

FIG. 2 discloses an enlarged portion of a side view cross section cut through a state of the art prefabricated sandwich wall element referred to in FIG. 1,

FIG. 3 discloses a side view cross section of the state of the art prefabricated sandwich wall element of FIG. 1,

FIG. 4 discloses a top-view cut at the level of an aluminium mesh of a prefabricated sandwich wall element according to the invention,

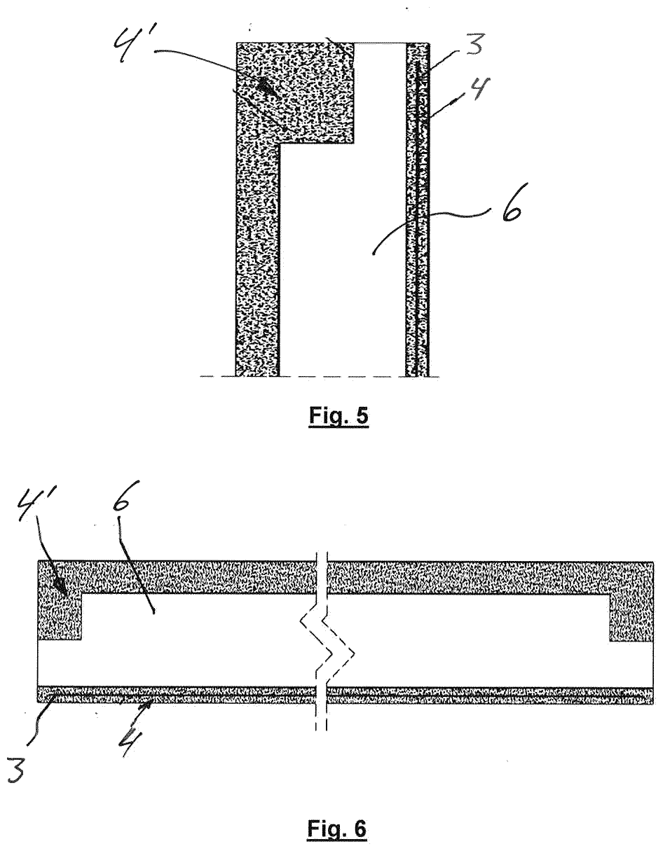

FIG. 5 discloses an enlarged portion of a side view cross section cut through a prefabricated sandwich element according to the invention and FIG. 4,

FIG. 6 discloses a side view cross section of the prefabricated sandwich element according to the invention and FIG. 4,

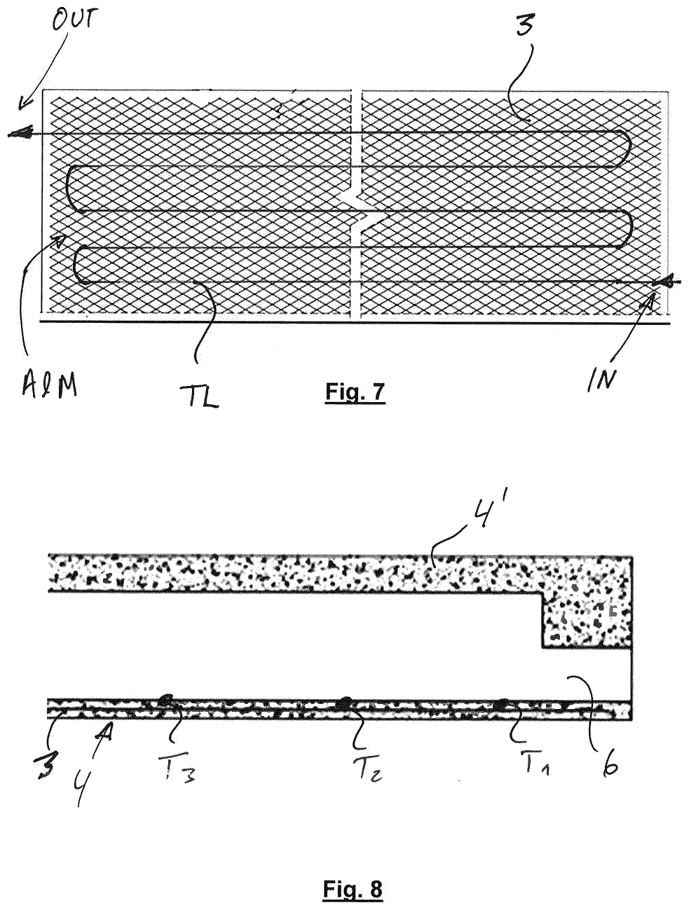

FIG. 7 discloses an aluminium mesh corresponding to that of FIG. 4 where a tubing loop is arranged at the mesh for heat transfer,

FIG. 8 discloses in more detail a tubing loop integrated with the mesh in a sandwich element according to the invention,

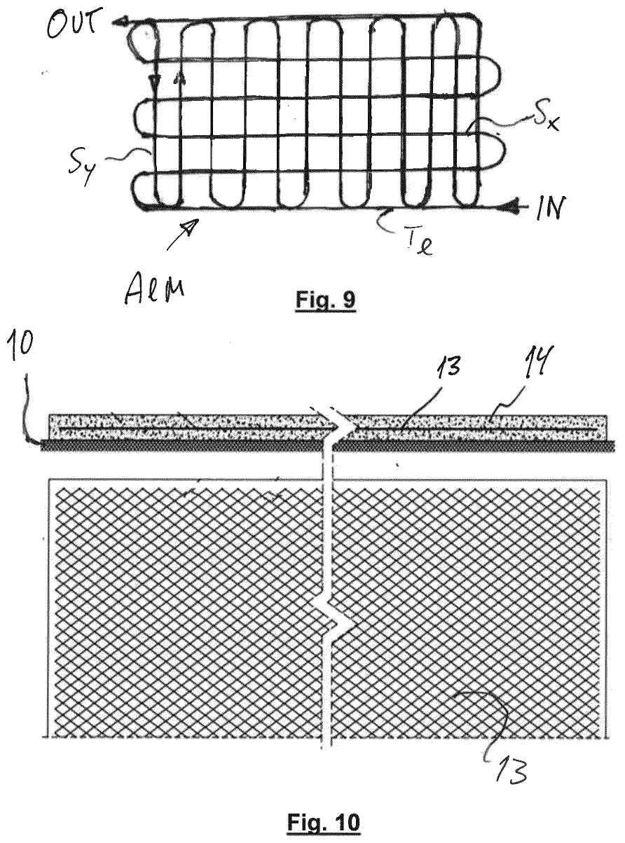

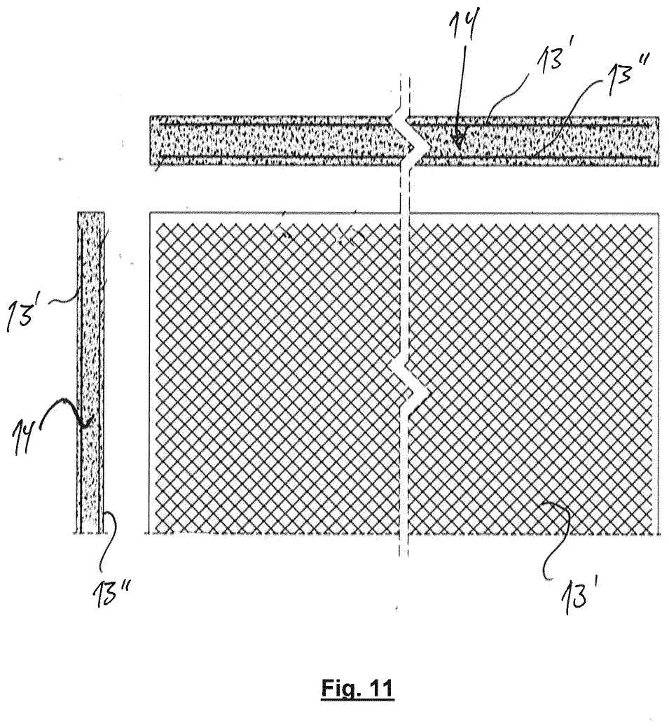

FIG. 9 discloses a tubing loop arranged in a manner where it may replace the reinforcement mesh,

FIG. 10 discloses a concrete floor slab according to the invention,

FIG. 11 discloses a prefabricated or in-situ casted concrete wall according to the invention with cross section views 1-1 and 2-2,

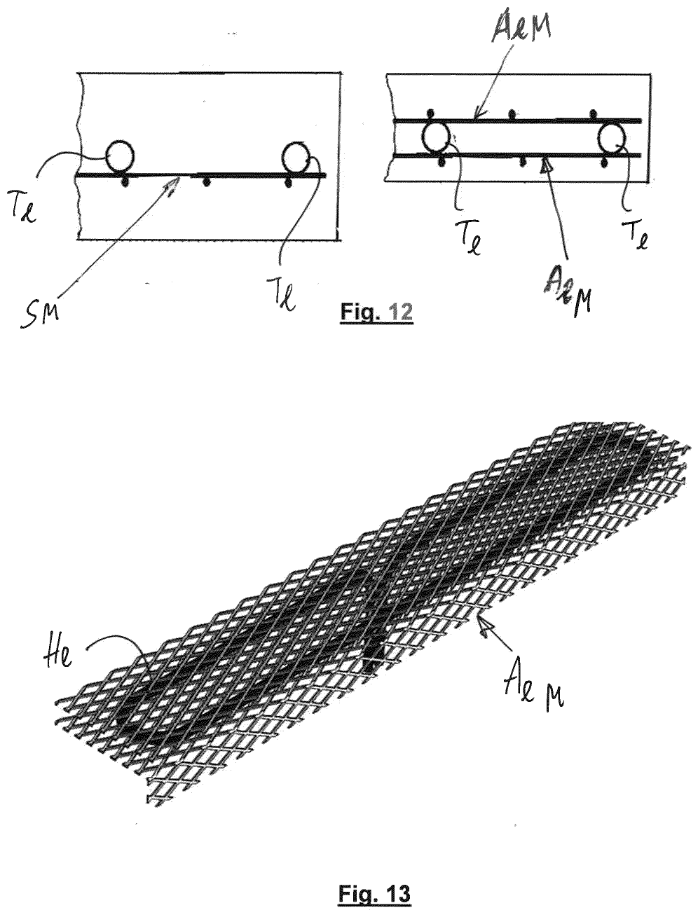

FIG. 12 to the left, discloses a state of the art step as a prefabricated element or in-situ casted concrete reinforced with steel mesh, where tubing loop for waterborne heat are casted in to keep the step ice-free,

FIG. 12 to the right discloses a step according to the invention, where the tubing loop is arranged at the aluminium mesh for heat transfer,

FIG. 13 discloses a sketch showing the aluminium mesh and a heating loop to be integrated in as a part of a prefabricated or in-situ casted step in a stairway corresponding to that of FIG. 12 to the right,

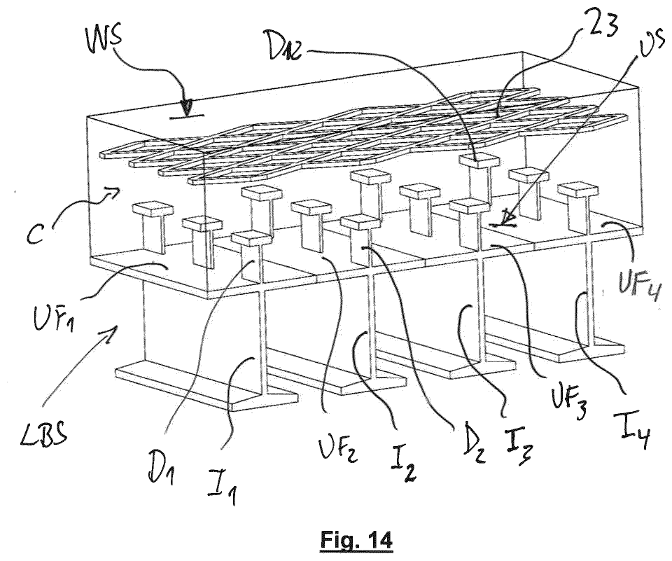

FIG. 14 discloses a sketch showing a load bearing structure having an aluminium mesh integrated in a top wear surface.

FIG. 1 discloses a top-view cut at the level of a mesh of a state of the art prefabricated sandwich element with steel mesh SM reinforcement. Further details of the steel mesh SM reinforcement are shown in FIG. 1, where the state of the art mesh SA3 is made of two set of rebars SA1, SA2 that cross each other and are connected in the crossing point by welding, demanding a building height two times the thickness of the rebars. One disadvantage when using steel reinforcement in the outer low stressed layer is that the steel reinforcement must be protected by approx. 40 mm quality concrete SA4 (FIG. 2) to protect the steel in relation to carbonation.

FIGS. 2 and 3 further discloses a layer of insulation SA6 and a second layer of concrete SA4′ as well as the mesh SA3 and the outer concrete layer SA4. The concrete layer SA4′ can be reinforced and depending on the application, dimensioned for carrying heavy loads when applied as a wall structure.

FIG. 3 discloses a side view cross section of the state of the art prefabricated sandwich wall element of FIGS. 1 and 2, where the upper part is a concrete layer SA4′, in the middle there is an insulation layer SA6 and at the bottom there is a steel mesh SA3 embedded in a concrete layer SA4.

FIG. 4 discloses a reinforcement mesh for a prefabricated sandwich element according to the invention. The mesh 3 indicated by reference AIM is made of an aluminium alloy and can be produced out of a plate material that can be rolled or extruded. Preferably the mesh 3 is made according to the slit—stretch technology as this will give good contact with the concrete and good force distribution due to its geometry, that preferably can be with rhombic or square shaped openings of the mesh and with twisted filaments with sharp cams based upon a rectangular cross-section.

FIG. 5 discloses an enlarged portion of a side view cross section cut through a prefabricated sandwich element according to the invention, having a central layer of insulation 6 covered at one side by a layer of concrete 4′. The concrete layer 4′ can be reinforced and depending on the application, dimensioned for carrying heavy loads when applied as a wall structure. At the other side of the insulation the element is provided with a reinforcement mesh 3 of aluminium embedded in an outer concrete layer 4. The first mentioned concrete layer 4′ and the insulation 6 can be state of art solution for instance as shown in FIG. 3 and indicated by SA4′ and SA6. That will say, depending on the actual application the concrete layer 4′ can be of a state of the art concrete and reinforced according to the state of the art.

FIG. 6 discloses a side view cross section of the prefabricated sandwich element of FIG. 5, with a reinforcement mesh 3 of aluminium. Due to its production technique, this mesh can be provided with a low building height. As seen in FIG. 6 the element has a central layer of insulation 6 covered at one side by a layer of concrete 4′ according to the state of the art, and at the other side being provided with a reinforcement mesh 3 embedded in an outer concrete layer 4 according to the invention.

One disadvantage when using steel reinforcement in the outer low stressed layer is that the steel reinforcement must be protected by approx. 40 mm quality concrete 4 (FIG. 2) to protect the steel in relation to carbonation. This problem can be solved with the present invention.

FIG. 7 discloses an aluminium mesh 3 corresponding to that of FIG. 4 and where a tubing loop TL is arranged onto or at the mesh for heat transfer. The tubing may be integrated in close contact with the mesh 3 made of aluminium, AIM, for good distribution of heat/cold in the sandwich element. The tubing may be of plastic, or other material but preferably of an aluminium alloy due to the good heat transfer properties of this material. It is also shown one inlet IN and one outlet OUT of the tubing loop. Instead of using a tube transporting the energy for heating, the aluminium mesh′ properties as a good conductor could be utilized by connecting it to i.e. solar panels.

FIG. 8 discloses in more detail parts of a similar tubing loop integrated with the mesh 3 in a sandwich element according to the invention, where in an enlarged end portion of the element there is shown in a side view cross section cut a central layer of insulation 6 covered at one side by a layer of concrete 4′ and at the other side being provided with a reinforcement mesh 3 embedded in an outer concrete layer 4. In close vicinity or in contact with the mesh, there is shown cross section cuts of some tubing loops, where three are indicated by T1, T2, T3. The size of the tubing loops are exaggerated to improve visibility in the Figure. Normally the loops should be well embedded in the concrete layer.

FIG. 9 discloses a tubing loop TL preferably of an aluminium alloy. This solution represents a tubing loop with two principal serpentines, and where the two serpentines are arranged in two basically perpendicular crossing directions, Sy, Sx, forming an aluminium mesh pattern. At the crossings of the two serpentine loops may be connected with each other. This may be done by pressing/welding, mechanical connection, bonding or any successful way of bonding. It is further shown one inlet IN and one and outlet OUT.

During manufacture, the two layers of serpentines may be pressed together at their crossing points to reduce the building height.

In some designs, the tubing loop may replace the reinforcement mesh, thus serving as a aluminium reinforcement, AlM. The thickness of the tubing wall can be designed as to influence the mechanical properties such as strength of the reinforcement.

FIG. 10 discloses a slab on the ground according to the invention. The upper part of the Figure is a cross-section cut through the slab, seen from the long side and the lower part is a top view cut at level of the mesh 13. The mesh is embedded in a concrete layer 14. The ground is marked with 10.

FIG. 11 discloses an un-isolated wall element according to the invention having two meshes 13′, 13″. The upper part of the Figure is a cross-section cut through the element, seen from the long side and the lower part is a top view cut at level of the mesh 13′. The two meshes 13′, 13″ are embedded with or without a concrete cover in the concrete layer 14. At the left side of the Figure there is shown a cross section cut through one short end of the element showing the main features of the element as mentioned above.

FIG. 12 to the left, discloses a state of the art step as a prefabricated element or in-situ casted concrete reinforced with steel mesh, where tubing loop for waterborne heat are casted in to keep the step ice-free,

FIG. 12 to the right discloses a step according to the invention, where the tubing loop is arranged at the mesh for heat transfer,

FIG. 13 discloses a sketch showing the aluminium mesh AlM and a heating loop to be integrated in as a part of a prefabricated or in-situ casted step in a stairway corresponding to that of FIG. 12 to the right,

FIG. 14 discloses a sketch showing a load bearing structure having an aluminium mesh in the compression part of the element. The mesh's function is to reduce or eliminate cracks in the concrete surface. If the composite structure goes continuously over a support, the mesh will take tensile forces, together with supplementary aluminium reinforcement adapted to the specific force.

Further details discloses a load bearing structure, LBS having I-beams, I1, I2, I3, I4 arranged in the lower part thereof. The I-beams are provided with one upper flange UF1, UF2, UF3, UF4 that forms an upper surface US. The upper surface is provided with dowels, D1, D2, . . . D12, here 12 dowels are shown. Above the dowels there is shown a reinforcing mesh 23.

Further to the disclosures, there are shown concrete aluminium-reinforced structures in accordance with the present invention, where there is applied a reinforcing mesh made of an aluminium alloy. In particular, this relates to a prefabricated concrete sandwich wall element with an aluminium mesh reinforcement arranged in the outer concrete layer.

The mesh disclosed is made of a sheet or extruded material that can be slitted and stretched to an expanded shape. The shape of the expanded parts secure good anchoring effects in the surrounding concrete. The aluminium mesh may not need a particular surface protection, but only fastened or covered with enough concrete to ensure mechanical anchoring of the concrete structure. This enables a percentage significant reduction in the thickness of the outer concrete structure, which reduces climate emissions and the use of materials, as well as reduces the weight of the element.

Initially, some manufacturing alternatives for an aluminium reinforcing mesh are considered the most relevant:

An industrial production method of aluminium mesh is based on expanded metal. Expanded metal mesh can be made from rolled plates or extruded profiles.

Perforating a sheet aluminium metal can be an option. The pattern of the mesh will be decided by the punching operation and shape of the die.

One other way of producing reinforcing meshes can be application of a screw extruder as a key part in a production line where meshes are made from extruded aluminium hollow profiles, tubes or rods with small diameter that are welded together.

The fabricated aluminium mesh is advantageous for use as reinforcement in various concrete structures in corrosive environment and where traditional steel meshes are used today.

The mesh of the reinforced composite plate shaped product can be of an aluminium alloy of a heat treatable type comprising AA4xxx or AA6xxx type.

The mesh of the reinforced composite plate shaped product can be an aluminium alloy of a non-heat treatable type and comprising one of AA1xxx, AA3xxx, AA5xxx or AA8xxx type.

The mesh of the reinforced composite plate shaped product can be an aluminium alloy made of recycled aluminium.

Typically, the following aluminium alloys can be used preferably as reinforcement; AA6082, AA319 (4xxx), AA3105, AA5050 type.

The E-modulus of aluminium metal is about ⅓ of that of steel whilst the density is about ⅓. The aluminium metal can be alloyed to modify the mechanical properties to approach steel in tensile strength while at the same time keeping the advantage of its light weight. In addition, the good formability of aluminium makes it possible to optimize the shape of the reinforcement to handle the forces that occur.

Al mesh enables a slimmer and lighter structure resulting in less use of materials as aggregate and cement. Due to less or no cover of the reinforcement.

In one embodiment a mesh with the characteristics as given below will be tested may be of geometrical dimensions as follows:
Mesh length 74 mm
Mesh width 36 mm
Wire width 4 mm
Wire thickness 3 mm
Light opening 77%

Further to the disclosure of FIGS. 7-9, where it is shown a construction panel in accordance with the present invention, and where there is applied a reinforcing mesh made out of an aluminium alloy together with a heat transfer tubing system. This makes the panel useful in many ways; for instance, as flooring panel in outdoor environment exposed to icing and snow as the tubing system can transport a heated medium for heat transfer. For instance, uncovered stairways and other pedestrian walkways can be covered with construction panels according to the invention where a heated medium pass through the tubing system integrated in the panel for heating purpose.

One other application is in façade panels where the tubing system can be integrated and used in outer wall panels for collecting heat from the sun. The heat may be applied for heating domestic water. The system will also have the effect that when in use, the indoor temperature may be kept lower. In particular, in hot summer days this may reduce the energy used for air conditioning.

1. A reinforced composite product comprising;
a concrete mix made of a binder of cement and an active pozzolana; and
an aggregate and water,
wherein
the active pozzolana replacement of cement >35%
and that the reinforcement is provided by one or more mesh(s) 3, 13 made of an aluminium alloy that is not provided with a protective coating.

2. The reinforced composite product according to claim 1,
wherein
the product is a structure exposed to low stress, or subject to compression or is an integrated part of a load bearing structure (LBS) where the part with said mesh is exposed to low stress.

3. The reinforced composite product according to claim 1,
wherein
the mesh is made of a sheet or profile aluminium metal rolled or extruded that is expanded by a slit—stretching process.

4. The reinforced composite product according to claim 1,
wherein
the mesh is made of a sheet or profile aluminium metal rolled or extruded where material is removed by punching providing a mesh with optimal force distribution.

5. The reinforced composite product according to claim 1,
wherein
the reinforced product is a façade panel.

6. The reinforced composite product according to claim 1,
wherein
the façade panel is integrated as an outer layer in an isolated sandwich wall element.

7. The reinforced composite product according to claim 1,
wherein
the reinforced product is a concrete floor slab, a concrete paving, walkway or step for a stairway.

8. (canceled)

9. The reinforced composite product according to claim 1,
wherein
the reinforced product is integrated as a top layer of a load bearing structure (LBS).

10. The reinforced composite product according to claim 1,
wherein
the reinforced product is integrated as a reinforcement and/or an electrical conductor.

11. The reinforced composite product according to claim 1,
wherein
the reinforced product has a tubing loop (T_{L}) for heat transfer.

12. The reinforced composite product according to claim 11,
wherein
the tubing loop (T_{L}) is integrated with the reinforcement mesh or used as reinforcement.

13. (canceled)

14. The reinforced composite product according to claim 1,
wherein
the aluminium alloy is of a heat treatable AA6xxx or 4xxx type,
or the aluminium alloy is of a non-heat treatable type and comprising one of AA1xxx, AA3xxx, AA5xxx or AA8xxx type.

15. (canceled)

16. (canceled)

17. The reinforced composite product according to claim 1,
wherein
the aluminium alloy is a cast alloy.

18. The reinforced composite product according to claim 1,
wherein
the aluminium alloy is made of primary or recycled aluminium.

19. The reinforced composite product according to claim 1,
wherein the binder comprises <65% cement and >35% active pozzolana.

20. The reinforced composite product according to claim 1,
wherein the binder comprises <60% cement and >40% active pozzolana.

21. The reinforced composite product according to claim 1,
wherein, wherein the binder comprises <55% cement and >45% active pozzolana.

22. The reinforced composite product according to claim 1,
wherein the binder comprises <50% cement and >50% active pozzolana.

23. The reinforced composite product according to claim 1,
wherein the binder comprises <45% cement and >55% active pozzolana.

24. The reinforced composite product according to claim 1,
wherein the binder comprises <40% cement and >60% active pozzolana.

25. The reinforced composite product according to claim 1,
wherein the binder comprises <35% cement and >65% active pozzolana.
